(19) United States
(12) Patent Application Publication
(10) Pub. No.: US 2007/0271155 A1
(43) Pub. Date: Nov. 22, 2007

(54) ONLINE PORTAL FOR VIEWING, ORGANIZING, AND SHARING INFORMATION RELATING TO REAL PROPERTY

(76) Inventors: Kaira Rouda, Columbus, OH (US); Jackie Cassara, Cleveland, OH (US); Erin Corrigan, Columbus, OH (US); Joyce Hanlon, Cleveland, OH (US); Craig Hauzie, Westerville, OH (US); Kristin Mohn, North Canton, OH (US); Becky Meckstroth, Hilliard, OH (US); Aaron Reiser, Bexley, OH (US); Meredith Wiseman, Columbus, OH (US); Jennifer Wright, Columbus, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/677,288

(22) Filed: Feb. 21, 2007

Related U.S. Application Data
(60) Provisional application No. 60/775,186, filed on Feb. 21, 2006.

(51) Int. Cl. G06Q 30/00

(52) U.S. Cl. 705/27

(57) ABSTRACT

A portal for a computer network for viewing and sharing information related to real property includes a web page for a registered user displaying a plurality of real property listings resulting from a search of current real property listings and a plurality of agent identifiers displayed on the web page representing real property agents associated with the registered user. Information is dragged and dropped by the registered user onto the agent identifier to share the information with the real property agent. Each of the real property agents preferably has a unique agent icon and the unique agent icons are displayed near information associated with the real property agent identified by the unique agent icon. The real property listings are preferably displayed on graphical images of cards.

### CROSS-REFERENCE TO RELATED APPLICATIONS

This application claims priority from U.S. Provisional Patent No. 60/775,186 filed on Feb. 21, 2006, the disclosure of which is expressly incorporated herein in its entirety.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an online portal or website of a global computer network such as the Internet and, more particularly, to an online portal for viewing, organizing, and sharing information relating to the marketing and sale of real property.

### BACKGROUND OF THE INVENTION

Selling and/or purchasing real property such as, for example, a residential home can be a very time consuming process. When selling your home, it is difficult to keep track of showings and open houses and requires nearly constant communication with your real estate agent by phone, email, or other means. When purchasing a home, it is difficult to keep track of all of the homes you have considered and/or viewed and their current status. To further complicate things, it is common to be selling a home while at the same time looking for a new home. After a period of time it is difficult to handle all of the information.

Many Internet sites have been developed where a consumer can search real property listings for homes etc. Once homes are located that the consumer would like more information or view, the consumer must contact their real estate agent or an agent identified on the website or by telephone or mail. While these websites make it easier and more convenient for consumers to view large quantities real property listings, they do not help the typical information overload and time pressures inherent with the process of purchasing and/or selling a home. In fact, these websites are designed to create more exposure for the homes which is good for sales but can further add to the information overload difficulty of the process for consumers. Accordingly, there is a need in the art for an improved system and method for viewing, organizing, and sharing information relating to real property.

### SUMMARY OF THE INVENTION

The present invention provides a system and method for viewing, organizing, and sharing information relating to real property which overcomes at least some of the above-noted problems of the related art. A portal for a computer network for viewing and sharing information related to real property comprises, in combination, a web page for a registered user displaying a plurality of real property listings resulting from a search of current real property listings and at least one agent identifier displayed on the web page representing a real property agent associated with the registered user. Information is dragged and dropped by the registered user onto the agent identifier to share the information with the real property agent.

According to another aspect of the invention, a portal for a computer network for viewing and sharing information related to real property comprises, in combination, a web page for a registered user displaying a plurality of real property listings resulting from a search of current real property listings and a plurality of agent identifiers displayed on the web page representing real property agents associated with the registered user. Each of the real property agents has a unique agent icon and the unique agent icons are displayed near information associated with the real property agent identified by the unique agent icon.

According to yet another aspect of the invention, a portal for a computer network for viewing and sharing information related to real property comprises, in combination, a web page for a registered user displaying a plurality of real property listings resulting from a search of current real property listings and at least one agent identifier displayed on the web page representing a real property agent associated with the registered user. The real property listings are displayed on graphical images of cards.

From the foregoing disclosure and the following more detailed description of various preferred embodiments it will be apparent to those skilled in the art that the present invention provides a significant advance in the technology and art of systems and methods for sharing and organizing information relating to real property. Particularly significant in this regard is the potential the invention affords for providing a high quality, reliable, secure, and easy to use system and method for sharing and organizing information. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a system and method of sharing and organizing information relating to real property according to a preferred embodiment of the present invention;

FIG. 2 is a diagrammatic view of a welcome or home page of an online portal of the system of FIG. 1;

FIG. 3 is a diagrammatic view of an initial properties tab of the online portal of FIG. 2;

FIG. 4 is a diagrammatic view of the properties tab of FIG. 3 but showing saved properties;

FIG. 5 is a diagrammatic view of the properties tab of FIG. 3 but showing a favorite property card slot;

FIG. 6 is a diagrammatic view of the properties tab of FIG. 3 but showing a property card located in the favorite property card slot;

FIG. 7 is a diagrammatic view of the properties tab of FIG. 3 but showing notes on the rear of a saved property card;

FIGS. 7A to 7C are a sequence of diagrammatic views showing the property card of FIG. 7 flipping over to display information on the other side of the property card;

FIG. 8 is a diagrammatic view of the properties tab of FIG. 3 but showing a bubble from a notes icon on the front of the property card;

FIG. 9 is a diagrammatic view of the properties tab of FIG. 3 but showing an initial bubble from an event icon on the front of the property card;

FIG. 10 is a diagrammatic view of the properties tab of FIG. 3 but showing a loaded bubble from the events icon on the front of the property card;

FIG. 11 is a diagrammatic view of the properties tab of FIG. 3 but showing an initial bubble from an agent file icon on the front of the property card;

FIG. 12 is a diagrammatic view of the properties tab of FIG. 3 but showing a loaded bubble from the agent file icon on the front of the property card;

FIG. 13 is a diagrammatic view of a searches tab of the online portal of FIG. 2;

FIG. 14 is a diagrammatic view of a my home tab of the online portal of FIG. 2;

FIG. 15 is a diagrammatic view of a bookmarks tab of the online portal of FIG. 2 wherein an articles portion is shown;

FIG. 16 is a diagrammatic view of the bookmarks tab of the online portal of FIG. 2 wherein a checklists portion is shown;

FIG. 17 is a diagrammatic view of the bookmarks tab of the online portal of FIG. 2 wherein a worksheets portion is shown;

FIG. 18 is a diagrammatic view of the bookmarks tab of the online portal of FIG. 2 wherein a quizzes portion is shown; and

FIG. 19 is a diagrammatic view of the agent portion of the home page of FIG. 2 wherein unique identifying colors can be selected for each related agent.

It should be understood that the appended drawings are not necessarily to scale, presenting a somewhat simplified representation of various preferred features illustrative of the basic principles of the invention. The specific design features of a system and method as disclosed herein, including, for example, specific dimensions, orientations, locations, and selections of the various components, will be determined in part by the particular intended application and use environment. All references to direction and position, unless otherwise indicated, refer to the orientation of the system illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved system and method disclosed herein. The following detailed discussion of various alternative and preferred embodiments will illustrate the general principles of the invention with reference to preferred embodiments. Other embodiments suitable for other applications and within the scope of the present invention will be apparent to those skilled in the art given the benefit of this disclosure.

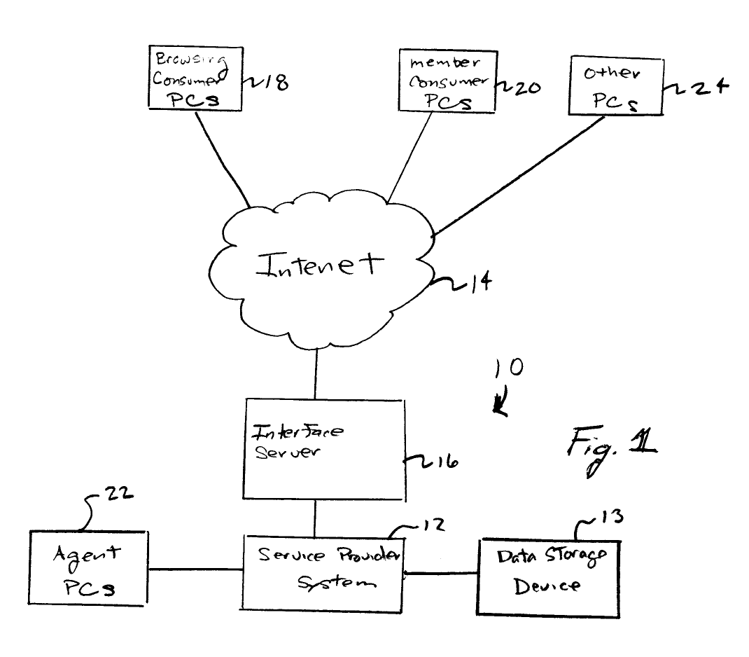

Referring now to the drawings, FIG. 1 schematically shows a system 10 for viewing, organizing, and sharing information relating to real property according to the present invention. The system 10 includes a service provider system 12 which is in communication with a data storage device 13 housing a database of current real property listings. The service provider system 12 establishes a website on the Internet 14 or the like via an interface server 16. Browsing consumers access the website via the Internet 14 or the like through personal computers 18 or the like and search for and view current real property listings and other related information. Consumers can register to establish an account at the website to obtain features such as organizing and sharing information with agents, family and/or friends as further described hereinafter. Registered or member consumers access the website via the Internet 14 or the like through personal computers 20 or the like to search, view and save current real property listings, share the listings and related information with selected agents, family and friends, and manage a personal calendar of events. Selected agents receive and share real property listings and related information via the Internet 14 or the like through personal computers 22 or the like linked directly to the service provider system 12 or via the Internet 14. Selected parties such as family and friends receive information via the Internet 14 or the like through personal computers 24 and the like.

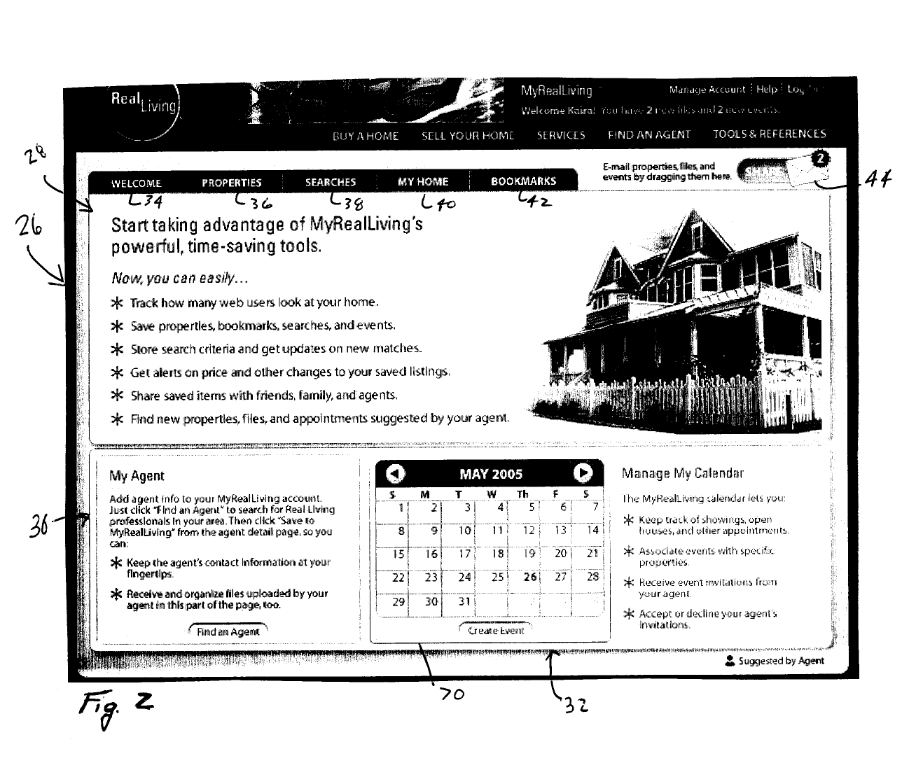

FIG. 2 shows a preferred main or home page 26 of the online portal. The home page 26 is shown when a registered user goes to the website and logs in or is otherwise identified. It is noted that an unregistered user has access for only limited demonstration purposes. To become a registered user, a user preferably must sign up with a registered real property agent associated with the portal. The illustrated home page 26 has three primary portions, the tab or working portion 28 located generally across the top half of the page 26, an agent portion 30 located generally at the bottom left quadrant of the page 26, and a calendar portion 32 generally located at the bottom right quadrant of the page 26. The illustrated tab portion 28 includes a welcome tab 34 where the user is provided with information about the website, a properties tab 36 where the registered user can organize information relating to specific real property listings which are of interest to the user, a searches tab 38 where the registered user, and their agent, can conduct and save the results of searches of real property listings, a my home tab 40 where the registered user can access and organize information regarding their own real property listings, and a bookmarks tab 42 where the registered user can access and share information relating to real property buying and selling and the like. The illustrated agent and calendar portions 30, 32 remain displayed as the registered user works with the tab portion 28 and changes between the various tabs 34, 36, 38, 40, 42 as shown hereinafter.

The illustrated home page 26 is also provided with a share icon 44 or the like located generally at the top right corner. The share icon 44 is used to share or send real property listings, events, articles or other files or information to others such as agents, family members and/or friends. The user simply clicks on an item to be shared and drags and drops it onto the share icon 44. The illustrated share icon 44 includes the word “SHARE”, a graphic image of an envelope, and a graphic image of a sunburst with a number therein indicating the number of new items that others have shared with the user. It is noted that the share icon can alternatively have any other suitable form. The illustrated home page 26 also includes a note 46 at the top right corner which indicates whether there are any new properties, files, events, notes etc. that others have shared with the registered user. Upon clicking the share icon 44, a share window opens where the user can select any number of listed items (which have been dragged and dropped into the share icon 44) to be sent, can select the email addresses of persons to receive the information from an email contacts list, and can add any personal message desired to be included in the email with the information being sent. Upon clicking a send button, the information is shared with the selected person persons.

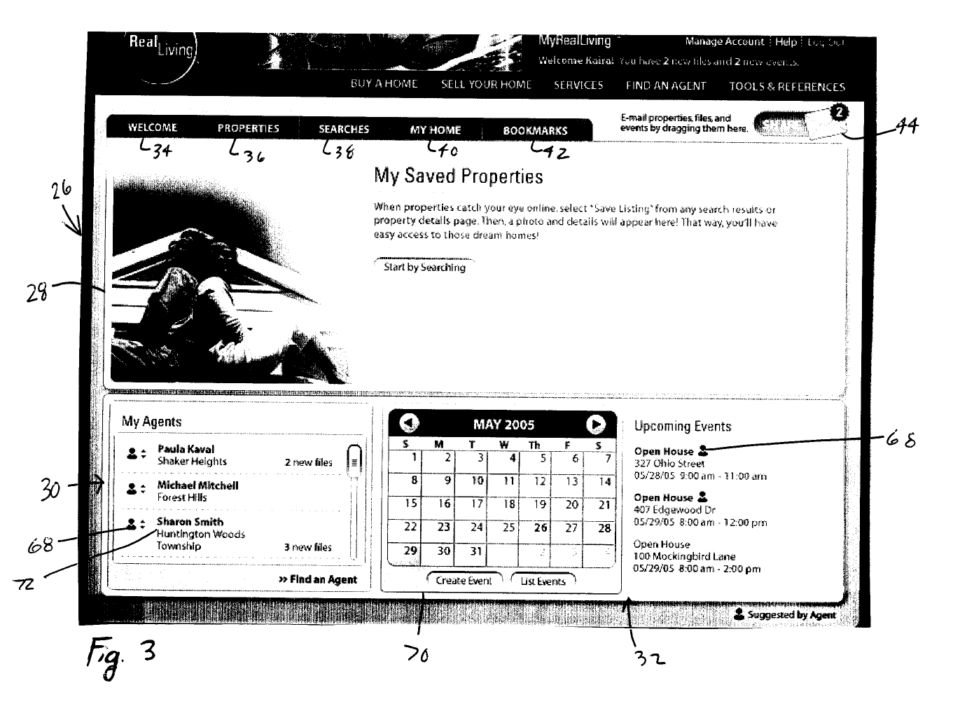

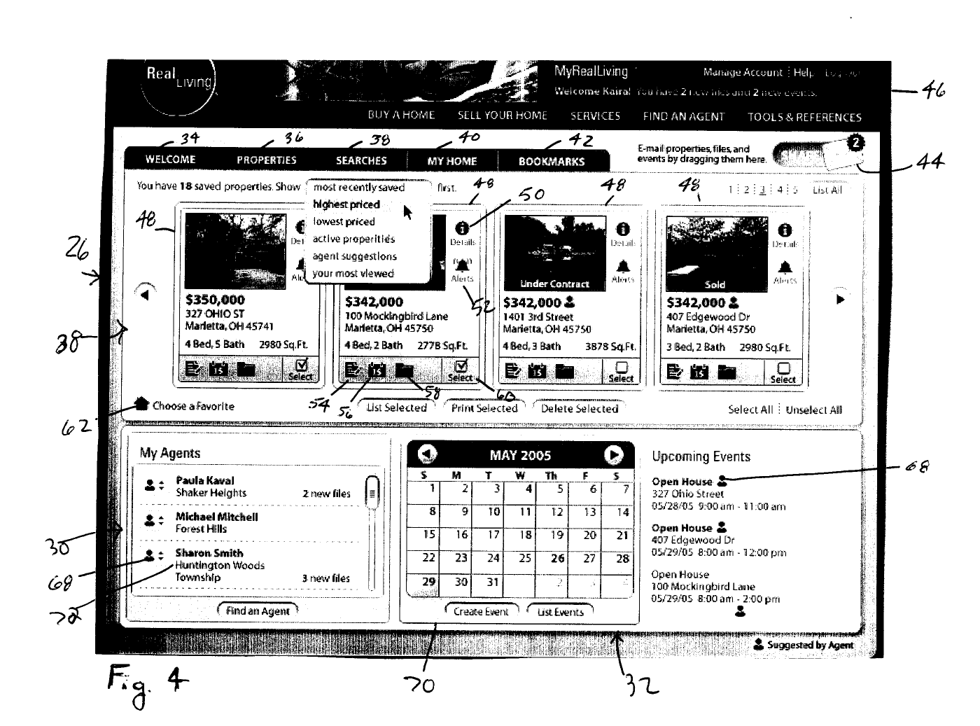

FIGS. 3 to 6 illustrate the preferred properties tab 36. FIG. 3 shows the properties tab 36 when no real property listings have been saved. A button is provided which enables the user to initiate a search of current real property listings. FIG. 4 illustrates that once a located real property listing has been saved, information regarding the saved listing is shown in the form of a property card 48. The illustrated property card 48 is the image of a thin rectangular-shaped card having a height greater than its width and having images and information provided thereon. The property card 48 is a graphical image of a card similar to collectable sports cards and the like. The illustrated properties tab 36 displays four of the property cards 48 at a time but any other suitable number can alternatively be utilized. The illustrated property cards 48 horizontally scroll across the top of the page by clicking on the left or right arrows to view any of the property cards 48 that have been saved. Additionally, the user can click on page numbers to display the various pages of the property cards 48. The user can select the order in which the property cards 48 are displayed such as, for example, by most recently saved, highest priced, lowest priced, active properties, agent suggestions, or your most viewed.

The illustrated property cards 48 each show a photograph of the real property, the listing price, the address, the number of bedrooms and bathrooms, and the square footage. It is noted that any other suitable information can alternatively be provided on the property cards 48. The illustrated property cards 48 also have a details icon 50 which can be clicked by the user to view more detailed information about the real property listing. The illustrated details icon 50 is a lower case “i” but can alternatively be formed in any other suitable manner. The illustrated property cards 48 also have an alert icon 52 which alerts the registered user that something has changed about that real property listing since the last time the registered user logged onto the portal. Changes can be, for example, the listing price has changed, the property is under contract, or the property has sold. The illustrated alert icon 52 is a graphic image of a bell which rings (visually by shaking and/or audibly by a ringing noise) when there is an active alert but it is noted that the alert icon 52 can be alternatively formed in any other suitable manner. The registered user clicks on the alert icon 52 to view information regarding the alert. Across the bottom, the illustrated property cards 48 have a note icon 54 which can be clicked to enter and view notes about the real property listing, an event icon 56 which can be clicked to view specific events associated with that real property listing, an agent folder icon 58 which can be clicked to view files from an agent specifically associated with that real property listing, and a select icon 60 which when selected can be used to list, share, print, delete, etc. selected property cards 48. The property cards 48 are also preferably provided with an icon or other suitable indicator whether the real property listing is currently active or inactive. It is noted that any other suitable icons can alternatively be provided on the property cards 48.

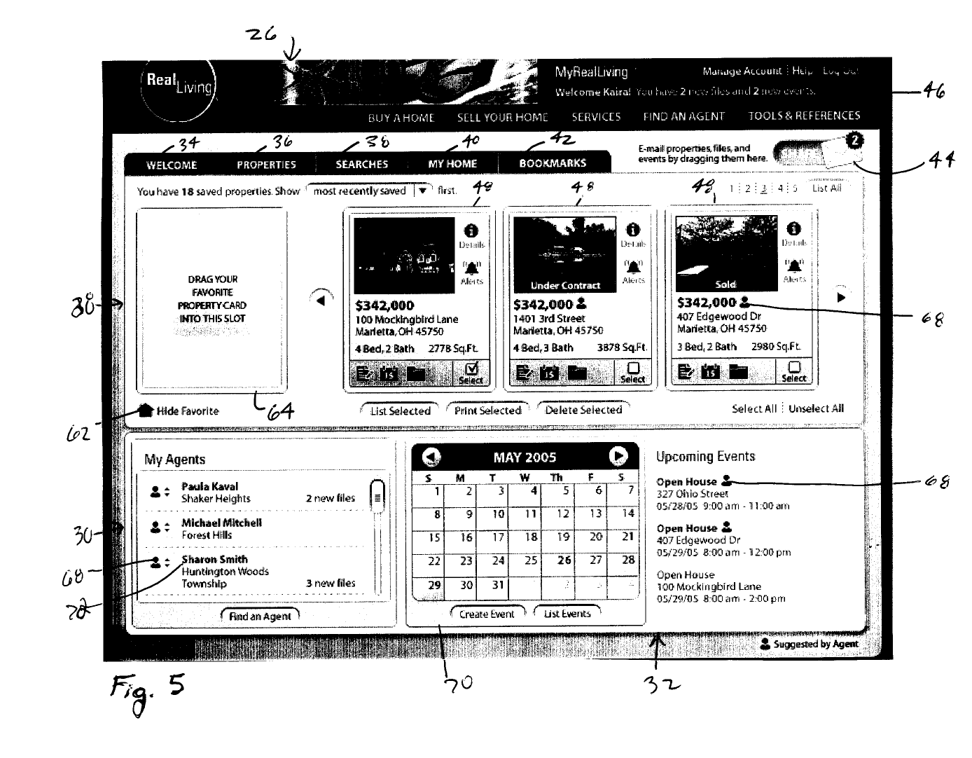

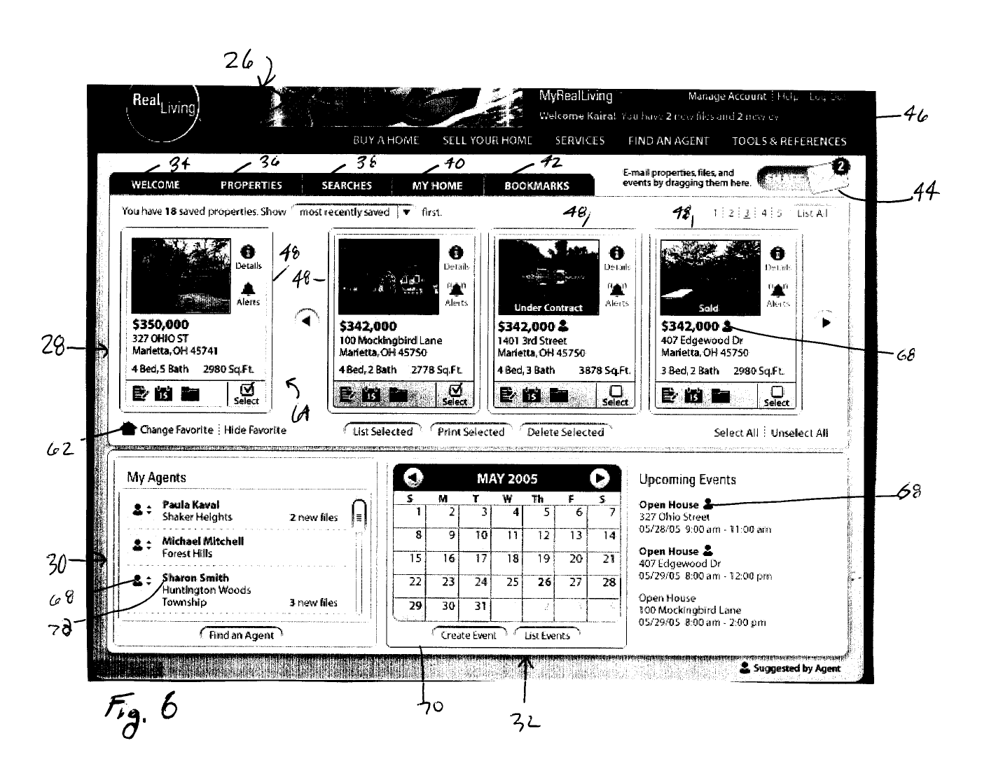

The illustrated properties tab 36 has a favorite icon 62 which when clicked, opens a slot or location 64 for constantly displaying the registered user's favorite one of the saved property cards 48. The illustrated favorite icon 62 includes a graphic image of a house but it is noted that the favorite icon 62 can alternatively be formed in any other suitable manner. As best shown in FIGS. 5 and 6, the illustrated slot is located at the left side of the row of four property cards 48 and can be filled by dragging and dropping any of the saved property cards 48 therein. When the favorite property card slot 64 is shown, it remains on the screen as the three other property cards 48 are horizontally scrolled. The user can hide or change the favorite property card by clicking on the favorite icon 62.

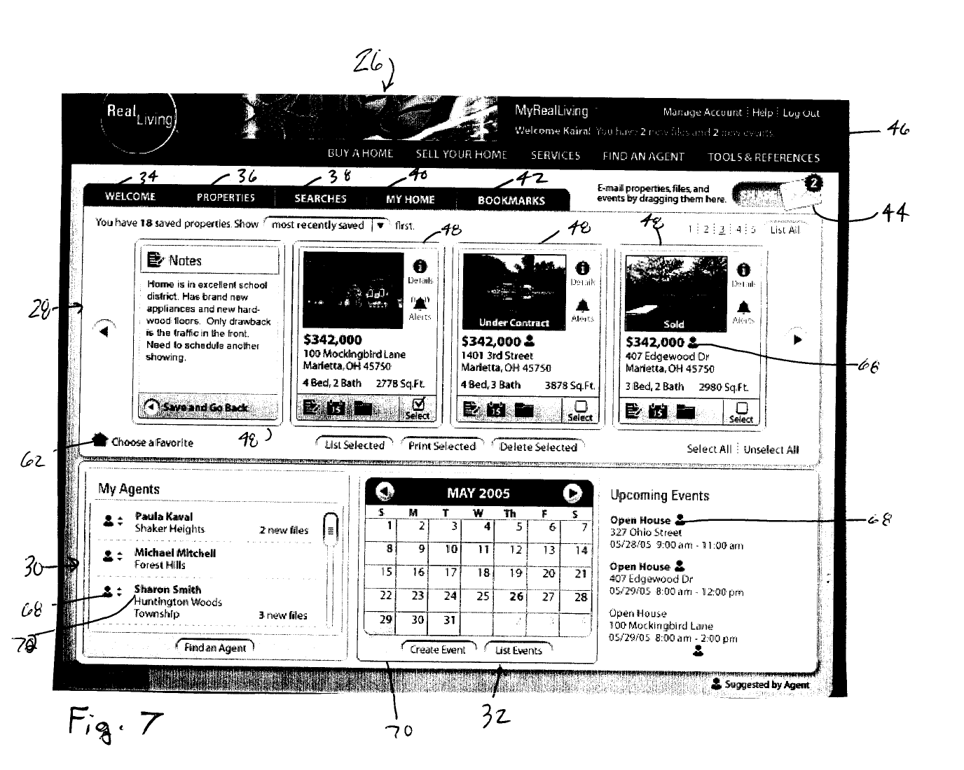

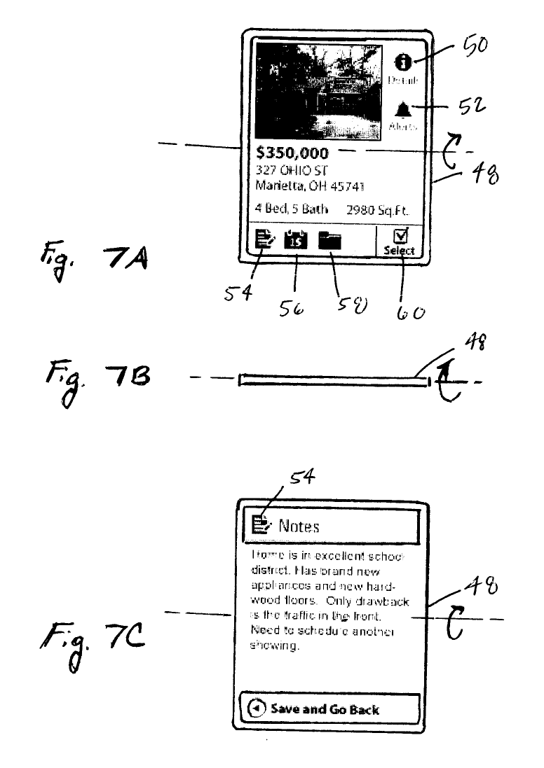

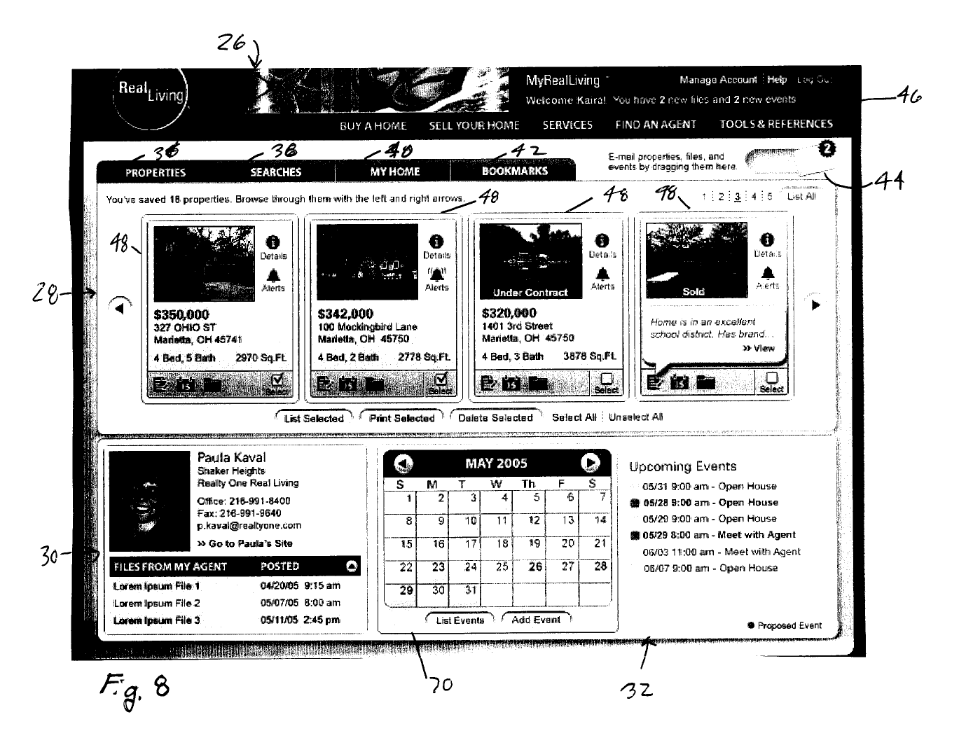

FIGS. 7 to 12 show use of several of the icons 54, 56, 58, 60 of the illustrated property cards 48. The illustrated note icon 54 is a graphic image of a piece paper with a pencil but it is noted that any other suitable form can alternatively be utilized. FIG. 7 shows that by clicking the note icon 54, the property card 48 flips over so that a rear side of the property card 48 is displayed. The illustrated rear side of the property card 48 permits notes regarding the property listing to be entered, saved, and viewed by the user. It is noted that the rear side of the property card 48 can alternatively be utilized for any other suitable purpose. As best shown in FIGS. 7a to 7C, the illustrated property card 48 visually flips over and the sound of a flipping card is provided when the note icon 54 is clicked. The illustrated property card 48 flips over a central horizontal axis but it is noted that the property card 48 can alternatively flip in any other suitable manner. FIG. 8 shows that when the property card 48 is not flipped, a bubble with at least a portion of any saved notes is displayed when the user hovers the curser over the notes icon 54 for a predetermined period of time.

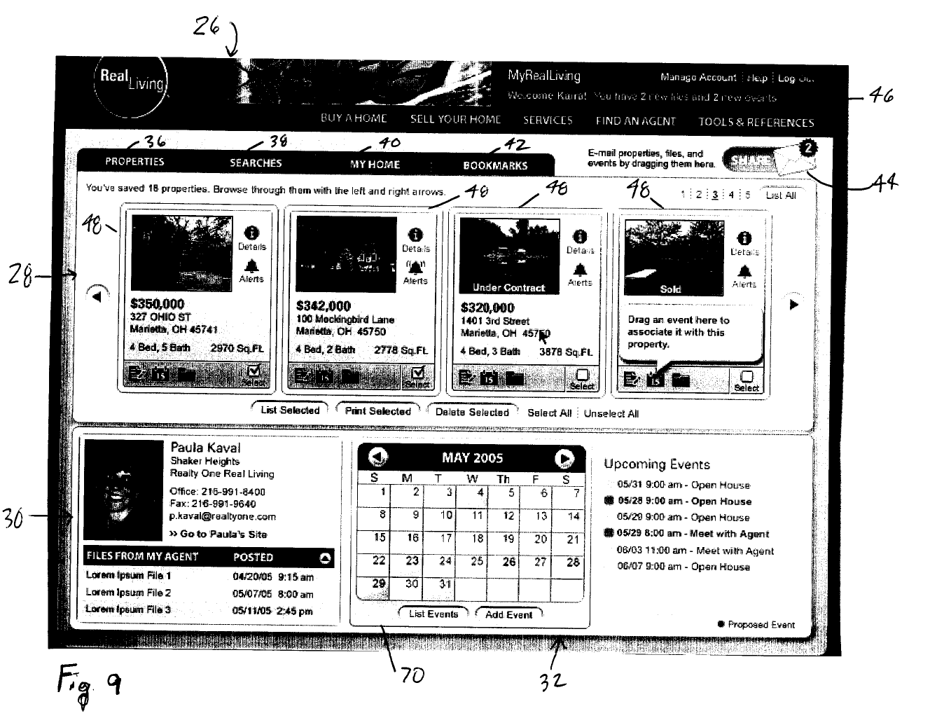

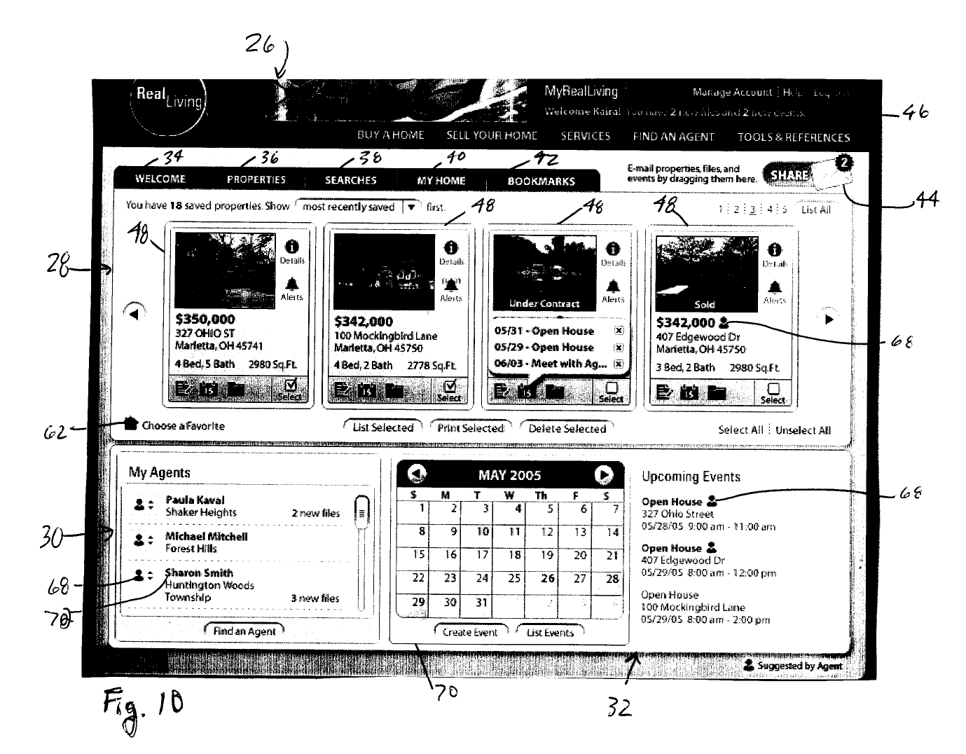

The illustrated events icon 56 is a graphic image of a calendar with a number thereon but it is noted that any other suitable form can alternatively be utilized. The displayed number indicates the number of calendar events that are associated with this particular real property listing. Events can be associated with the real property listing by dragging and dropping an event onto the events icon 56 on the property card 48 for that real property listing. FIG. 9 shows that a bubble is displayed when the user hovers the curser over the notes icon 56. FIG. 10 illustrates that the bubble displays a listing of at least a portion of the events associated with this particular real property listing when the user hovers the curser over the events icon for a predetermined period of time. By clicking the events icon 56, the listing of the events associated with this particular real property listing is displayed.

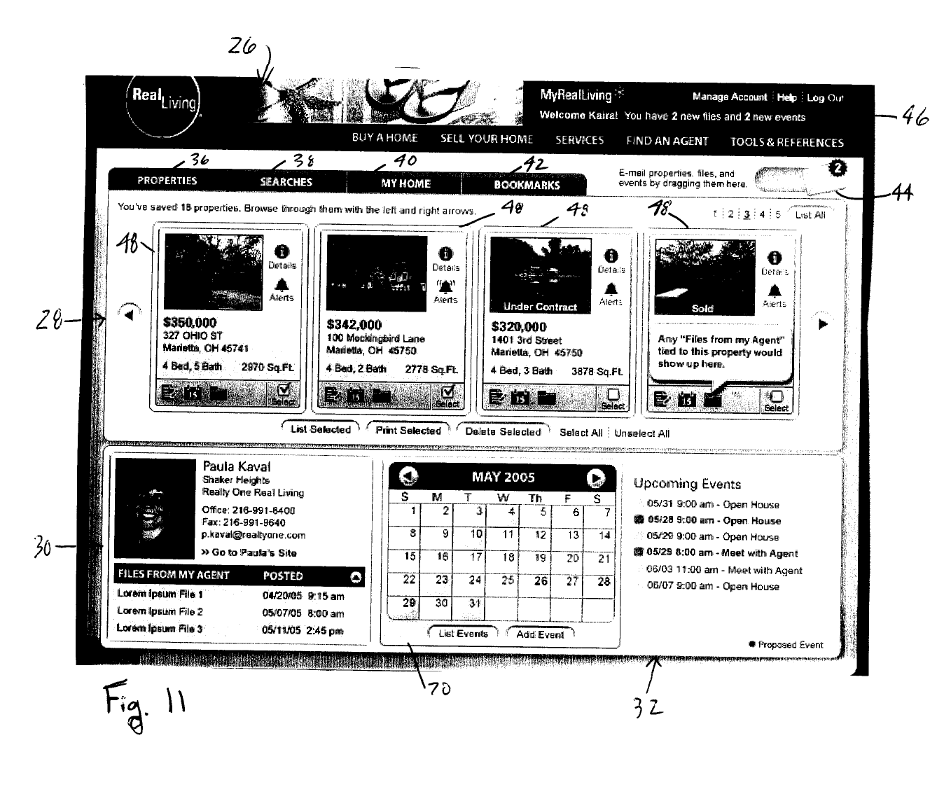

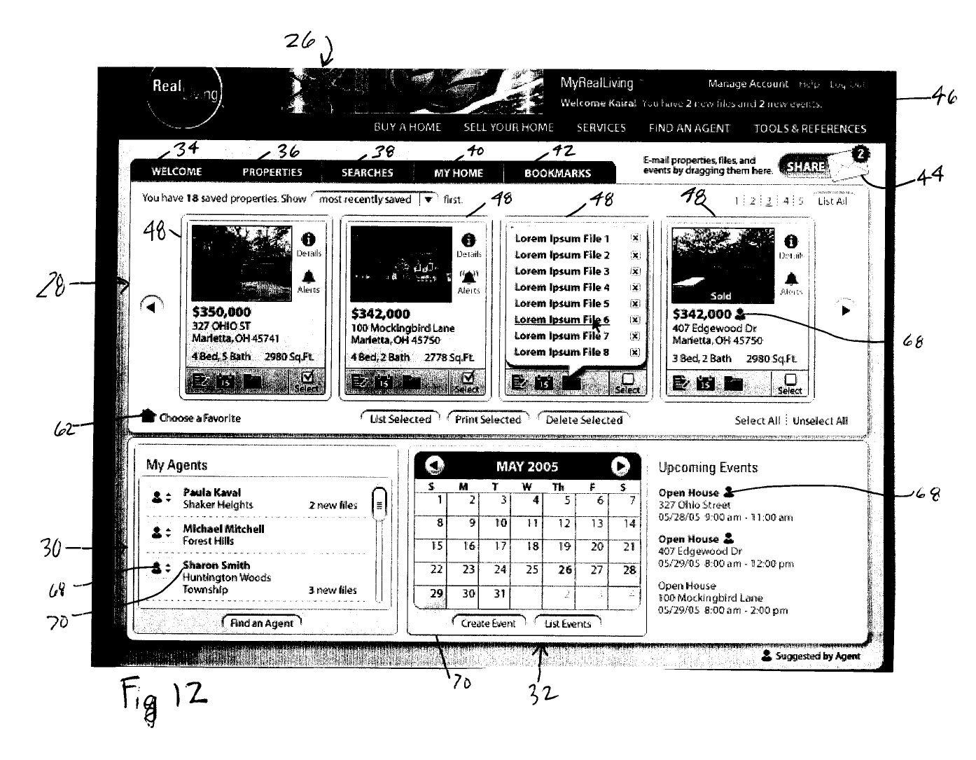

The illustrated agent folder icon 58 is a graphic image of a file folder but it is noted that any other suitable form can alternatively be utilized. FIG. 11 shows that a bubble is displayed when the user hovers the curser over the agent file icon 58. FIG. 12 illustrates that the bubble displays a listing of at least a portion of the files associated with the particular real property listing. Files that are shared by an agent with the user are automatically linked to their associated real property listing. By clicking the agent files icon 58, the listing of the associated files that have been shared by the agent is displayed.

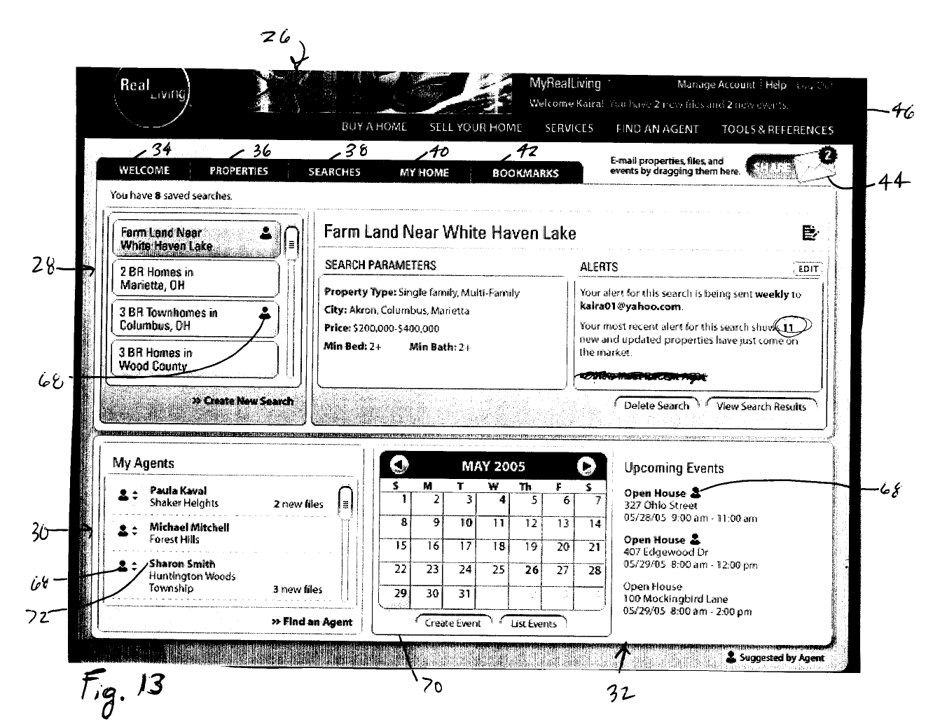

FIG. 13 shows the preferred searches tab 38 of the online portal from which saved search results can be viewed and edited and new searches can be created by the registered user. The illustrated searches tab 38 displays a listing of stored searches at the left side which can be vertically scrolled. Details of a selected one of the stored searches are displayed on the right side of the searches tab 38. The illustrated details include search parameters and alerts but any other suitable details can alternatively be displayed. The illustrated search parameters include property type, city, price, minimum number of bedrooms, and minimum number of bathrooms. The illustrated alerts indicates how often the search is being rerun and the results sent to the user as well as the number of changes in the search the last time the search was run.

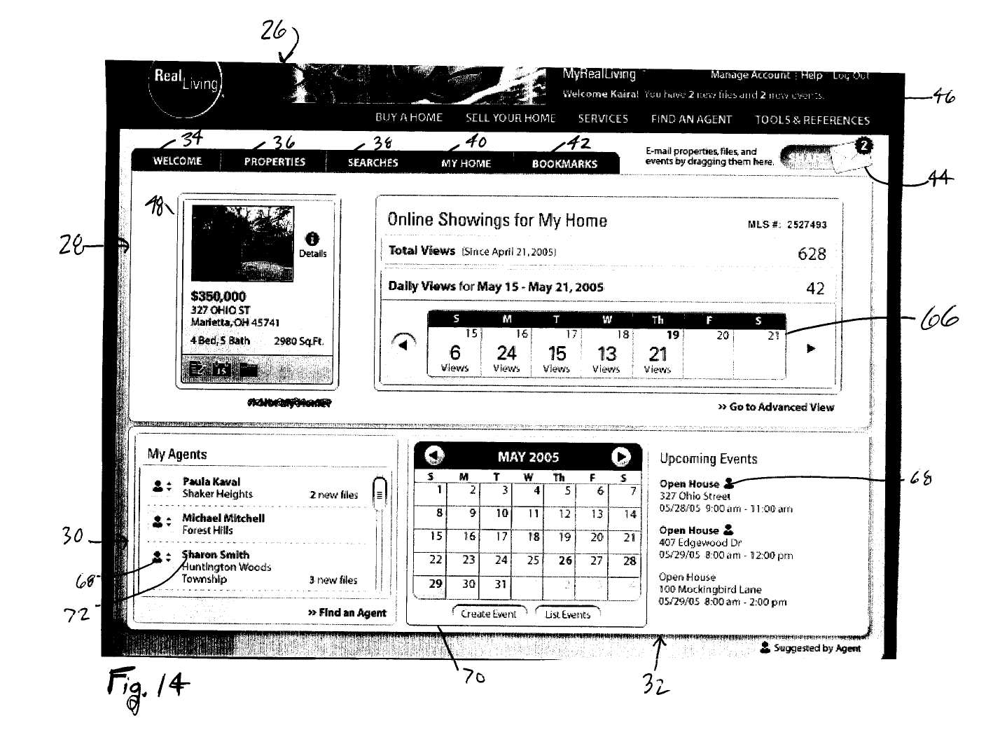

FIG. 14 shows the preferred my home tab 40 of the online portal wherein the status of online showings or views can be viewed by a registered user selling a particular property. The illustrated my home tab 40 displays the property card 48 of the user's real property on the left side and a summary of online showings on the right. The illustrated my home tab 40 shows the total quantity of online showings for the home, that is, the number of times the property card 48 has been viewed since a listing date or other suitable date, and a seven-day calendar 66 showing the total number of views on each displayed day. The calendar 66 can be scrolled horizontally to display any seven day period. Also displayed, is a total number of views for the seven periods displayed on the calendar 66. Thus, the may home tab 40 provides real-time access to activity of the real property on the Internet, that is, web site hits, open houses, etc. It is noted that this real-time viewing information can alternatively be displayed in any other suitable manner. The my home tab 40 is established by a real estate agent associated with the portal through which the registered user has listed real property for sale.

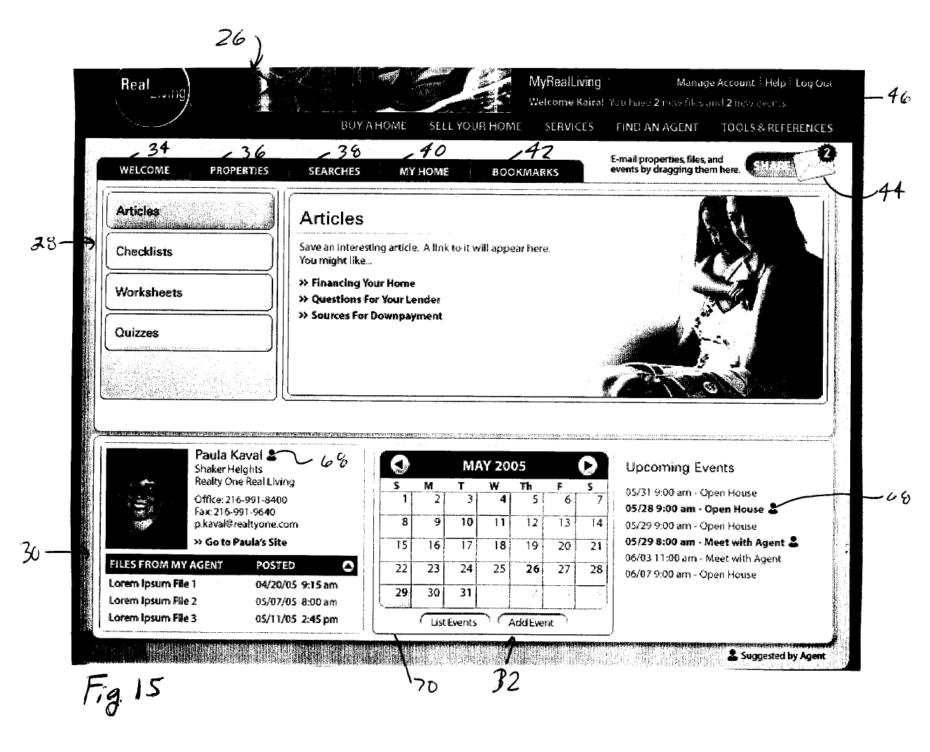

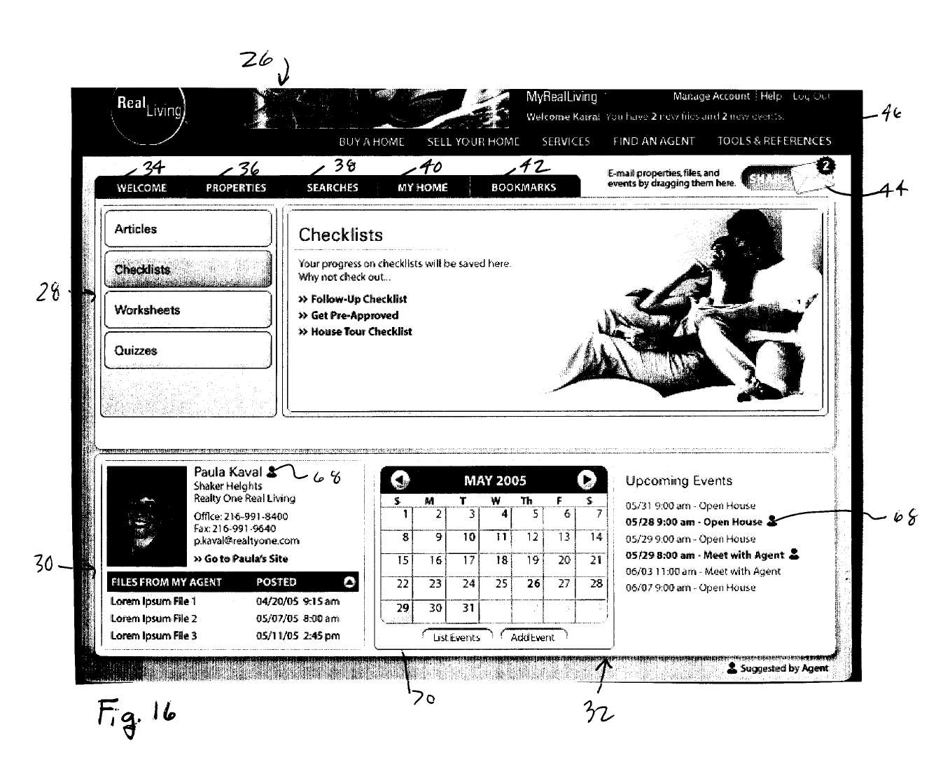

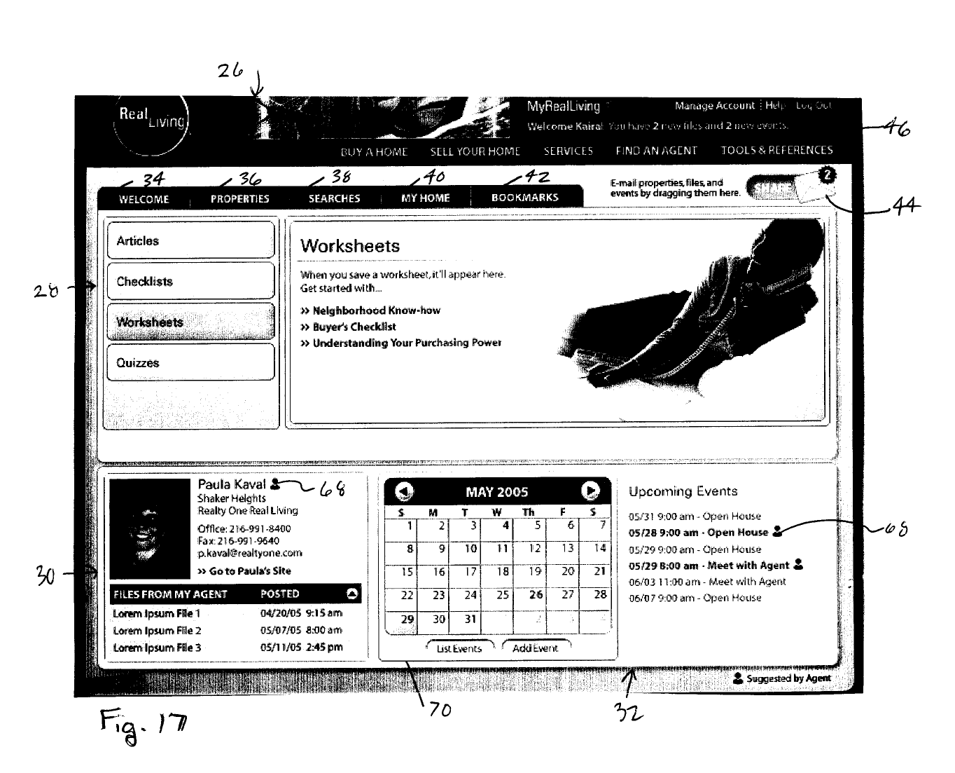

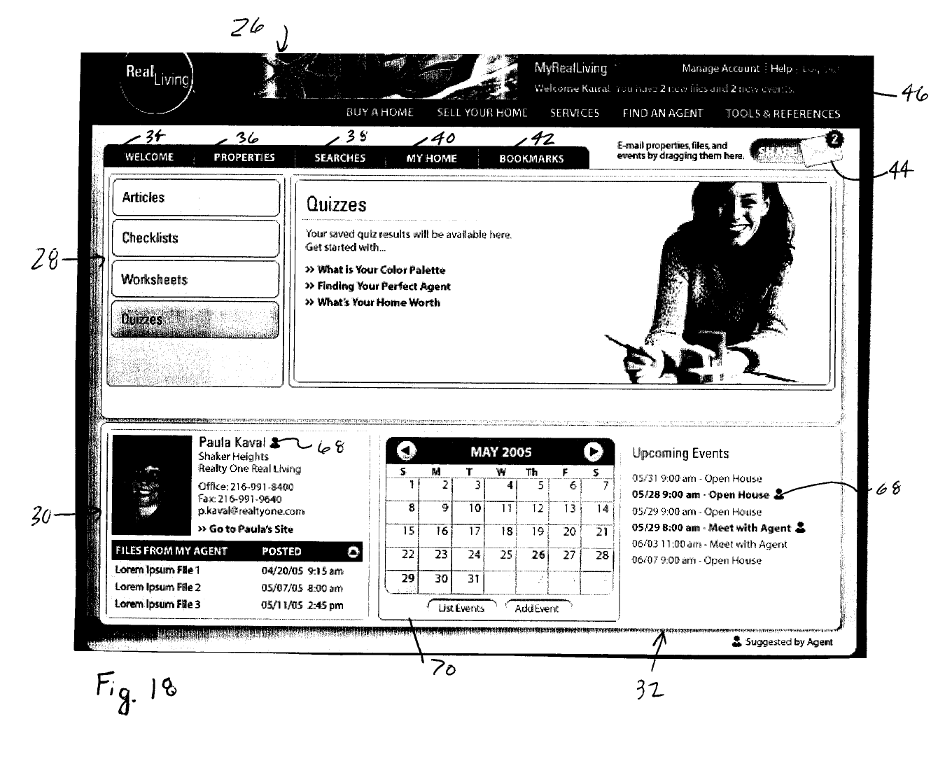

FIGS. 15 to 18 show the preferred bookmarks tab for the online portal wherein the registered user can view and share information. FIG. 15 shows an articles portion containing links to articles that the user saves. FIG. 16 displays a checklists portion wherein links to various checklists related to buying and selling real property can be saved. FIG. 17 displays a worksheets portion wherein links to worksheets related to buying and selling real property can be saved. FIG. 18 displays a quizzes portion wherein links to quiz results related to real property can be saved.

As best shown in FIG. 2, the illustrated agent portion 30 of the home page 26 enables the registered user to locate real estate agents and link them to their personal page so that the agents contact information is readily available and files and other information can be received from the agent and shared with the agent. As best shown in FIG. 3, a listing of all linked agents or agent identifiers 72 are displayed once any agents are linked by the user. The illustrated listing identifies agents by name and location but they can alternatively be identified in any other suitable manner. The illustrated list of linked agents can be vertically scrolled. Once linked, a linked agent can directly share files or other information with the user directly through the system without the need to send emails. Each agent has their own personal page through which they can view and share information. The illustrated listing displays the receipt of any new files from each of the linked agents. As best shown in FIG. 8, when a particular agent is selected, contact and other information regarding that linked agent is displayed along with a list of files received from that agent and the date and time each of the files were received. The registered user can choose to either accept to receive the information or decline to receive the information. The registered user can also share information with the agent by simply dragging and dropping onto the agent in the agent portion.

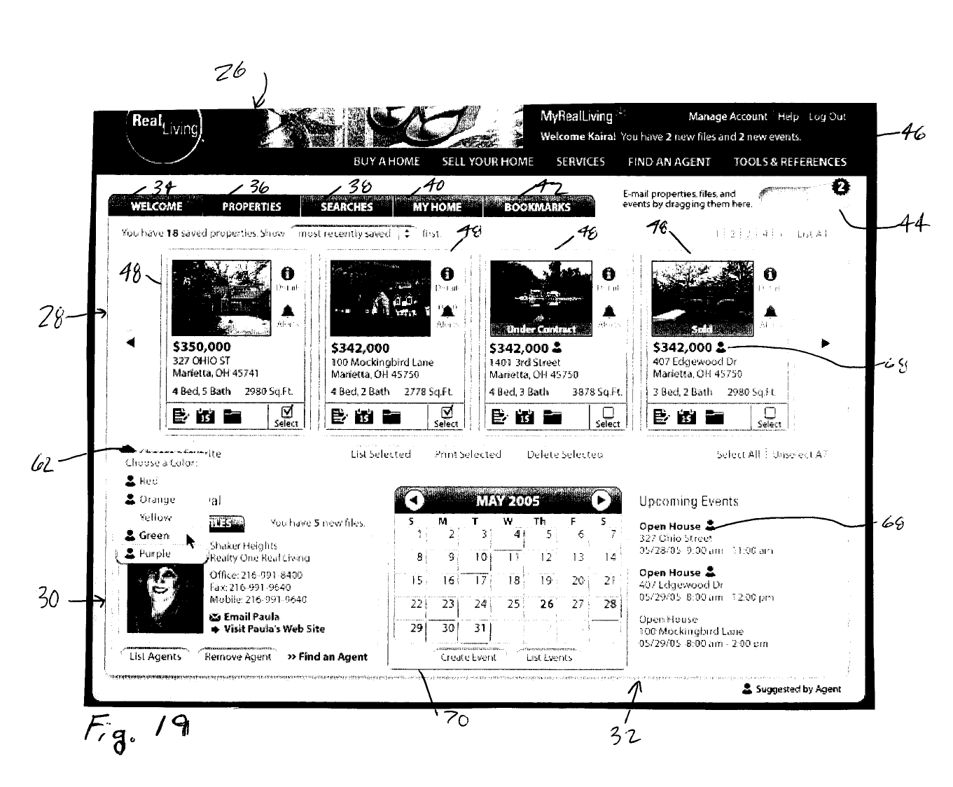

When a linked agent sends files, events, search results, property cards etc., the information sent by the agent is identified as being provided by the agent by the use of an agent icon 68. The agent icon appears on property cards, calendar events etc. so that it can be easily identified what information was received from what agent. The illustrated agent icon 68 is a graphic image of the head and shoulders of a person but it is noted that the agent icon 68 can alternatively be formed in any other suitable manner. The agent icons 68 are preferably color coded so that each linked agent has an agent icon 68 associated with them that has a unique color. As best shown in FIG. 19, the registered user can preferably choose particular colors to be associated with each linked agent. The unique icons 68 permit the user to work with any number of agents and easily identify which information or event is associated with which agent. It is noted that the agent icons 68 can alternatively be unique in other manners besides color such as, for example, each agent could have a unique icon shape or the like.

As best shown in FIG. 2, the illustrated calendar portion 32 of the home page 326 enables the registered user to organize their schedule. The illustrated calendar portion displays a one month calendar 70 and a listing of upcoming events. Days having events connected therewith are highlighted. By clicking on a particular day on the calendar 70, a list of the events on that day is displayed. The user can create, edit and delete the events. Also displayed are events suggested by any of the linked agents as identified by their agent icons 68. The user can link the calendar events to a particular property card 48 by dragging and dropping the event onto the event icon 56 on the particular property card 48.

It is apparent from the above detailed description of preferred embodiments of the present invention, that the system and method of the present invention enables consumers to view, organize, and share information related to real property with improved results over prior systems and methods. It is also apparent that registered users can save and archive information regarding sales and purchases which can be later accessed when needed such as additional sales and/or purchases.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A portal for a computer network for viewing and sharing information related to real property, said portal comprising, in combination:
a web page for a registered user displaying a plurality of real property listings resulting from a search of current real property listings;
at least one agent identifier displayed on the web page representing a real property agent associated with the registered user; and
wherein information is dragged and dropped by the registered user onto the agent identifier to share the information with the real property agent.

2. The portal according to claim 1, further comprising a share icon displayed on the web page, wherein information is dragged and dropped by the registered user onto the share icon to email the information to selected email addresses.

3. The portal according to claim 1, a web page for the real property agent associated with the registered user where information can be directly received from the registered user and directly shared with the registered user.

4. The portal according to claim 3, wherein the registered user chooses one of accepting to receive the information from the real property agent and declining to receive the information from the real property agent.

5. The portal according to claim 1, wherein there are a plurality of agent identifiers and each of the agent identifiers is identified by a unique agent icon.

6. The portal according to claim 5, wherein the unique agent icons are different colors.

7. The portal according to claim 5, wherein the unique agent icons are displayed near information associated with the real property agent identified by the unique agent icon.

8. The portal according to claim 1, wherein the real property listings are displayed on graphical images of cards.

9. The portal according to claim 8, wherein the cards can be flipped over to display rear sides of the cards.

10. The portal according to claim 8, wherein a predetermined plurality of the cards are displayed at the same time and the registered user can scroll through all stored real property listings.

11. The portal according to claim 10, wherein the plurality of cards are displayed in a row and scroll horizontally.

12. The portal according to claim 11, further comprising a favorite card position which continuously displays a favorite one of the cards while the other cards are scrolled.

13. The portal according to claim 12, wherein the registered user selects one of the cards to be displayed in the favorite card position

14. The portal according to claim 8, wherein the cards have icons indicating whether the real property listing is currently active.

15. The portal according to claim 8, wherein the web page displays a calendar of events and events can be dragged and dropped by the registered user onto the cards to associate the events with particular real property listings.

16. The portal according to claim 1, wherein the web page displays real-time information regarding the number of online viewings for a real property listing owned by the registered user.

17. The portal according to claim 15, wherein an associated agent of the registered user establishes the real-time information.

18. The portal according to claim 1, wherein the registered user must register with a real property agent affiliated with the portal.

19. A portal for a computer network for viewing and sharing information related to real property, said portal comprising, in combination:
a web page for a registered user displaying a plurality of real property listings resulting from a search of current real property listings;
a plurality of agent identifiers displayed on the web page representing real property agents associated with the registered user; and
wherein each of the real property agents has a unique agent icon and the unique agent icons are displayed near information associated with the real property agent identified by the unique agent icon.

20. A portal for a computer network for viewing and sharing information related to real property, said portal comprising, in combination:
a web page for a registered user displaying a plurality of real property listings resulting from a search of current real property listings;
at least one agent identifier displayed on the web page representing a real property agent associated with the registered user; and
wherein the real property listings are displayed on graphical images of cards.
